(19) United States
(12) Patent Application Publication
(10) Pub. No.: US 2010/0123073 A1
(43) Pub. Date: May 20, 2010

(54) ELECTRON CAPTURE DISSOCIATION IN A MASS SPECTROMETER

(75) Inventors: William Clay Guest, Winnipeg (CA); Vladimir Montero Collado, Winnipeg (CA); Victor Lloyd Spicer, Winnipeg (CA); Mitchell Craig Bushuk, Winnipeg (CA); Kenneth Graham Standing, Winnipeg (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: UNIVERSITY OF MANITOBA, Winnipeg, MN (CA)

(21) Appl. No.: 12/525,420

(22) PCT Filed: Jan. 31, 2008
(86) PCT No.: PCT/CA2008/000194

§ 371 Date: Jan. 14, 2010

Related U.S. Application Data
(60) Provisional application No. 60/887,445, filed on Jan. 31, 2007.

(51) Int. Cl. H01J 49/40; H01J 27/00; H01J 49/10; G21K 1/00

(52) U.S. Cl. 250/282; 250/287; 250/281; 250/423 R; 250/505.1; 250/424

(57) ABSTRACT

A mass spectrometer, that may be a time of flight mass spectrometer, has a source of ions having desired characteristics. The mass spectrometer section includes a modulator and first and second apertures on opposite sides of the modulator, with the first aperture providing a connection to the source of ions. A cell is connected to the modulator of the time-of flight mass spectrometer section by the second aperture, whereby, in use, ions from the source of ions can pass through the first aperture, the modulator and the second aperture into the cell, for capture of electrons or collision with a gas, to generate daughter ions, and the daughter ions are passed back into the time-of-flight or other mass spectrometer section for analysis.

### FIELD

This invention relates to a mass spectrometer, more particularly a quadrupole/time-of-flight mass spectrometer, with capabilities to study daughter or secondary ions generated by, for example, electron capture dissociation (ECD).

### BACKGROUND

The following paragraphs are not an admission that anything discussed in them is prior art or part of the knowledge of persons skilled in the art.

Recently developed electron capture dissociation (ECD), and electron transfer dissociation (ETD) techniques are important complements to the usual collision-induced dissociation (CID) method for the production of structurally-informative ions. These new methods tend to cleave peptides along their backbones, leaving the side chains intact, so they are especially useful for the analysis of post-translational modifications. Under some conditions (“hot electron capture dissociation”—HECD), they also have the ability to distinguish between isomeric leucine and isoleucine residues. Moreover, they are often more effective than CID in breaking up large parent ions, since a recombination energy of 4 to 7 eV per parent ion is available, (unlike CID, which relies on the collision energy in the centre-of-mass system).

A recent proposal by Syka et al implements ETD in a quadrupole ion trap (J. E. Syka, J. J. Coon, M. J. Schroeder, J. Shabanowitz and D. F. Hunt, Proc Natl Acad Sci USA 101 9528-33 (2004)), but practical applications of ECD have until recently been restricted to FTICR spectrometers (H. J. Cooper, K. Hakansson and A. G. Marshall, Mass Spectrom Rev 24 201-22 (2005)) because of the perceived need for a long interaction time between the necessary low energy electrons (<0.3 eV), and the parent ions. However, this interaction time (originally ˜sec) can be reduced by several orders of magnitude (to ˜ms) by supplying high electron density with improved electron sources (such as dispenser cathodes), so the very long storage times provided by FTICR are no longer necessary. In addition, there are reasons why FTICR spectrometers are still far from an ideal solution to the problem:

FTICR instruments are presently an expensive and complicated variety of mass spectrometer, so the number of laboratories able to implement the technique in this way is likely to remain limited.

Even in FTICR spectrometers the ECD fragmentation efficiency is not very high, at least for doubly charged parents (e.g. ˜10% at 1570 Da as reported by M. A. McFarland, M. J. Chalmers, J. P. Quinn, C. L. Hendrickson, A. G. Marshall, J Am Soc Mass Spectrom 16 1060-1066 (2005)).). This is probably caused by the low electron density achieved in this configuration, the high degree of coherence in the FTICR cyclotron/magnetron motion of the ions, and the confinement of an electron very close to a given line of force by the strong magnetic field; it has been suggested in this paper that once “the electrons . . . bleach a hole through the ion cloud”, the undissociated ions “ . . . never come into contact with the electrons” The coherence could probably be modified by gas collisions, but admission of gas to the FTICR chamber is a time-consuming and inefficient process.

It would be useful to make these methods available for use in other types of instrument if reasonable sensitivity can be achieved, and particularly if the measurements can be carried out on a time scale compatible with HPLC (High Performance Liquid Chromatography). Considerable progress in this direction has recently been reported. Zubarev has observed ions formed by ECD in a 3-D quadrupole ion trap (D. A. Silivra, I. A. Ivonin, F. Kjeldson and R. A. Zubarev, 52^{nd} ASMS Conference, Nashville Tenn., May 2004), (O. A. Silivra, F. Kjeldsen, I. A. Ivonin, R. A. Zubarev, J Am Soc Mass Spectrom 16 22-27 (2005), although at fairly low intensity. Baba et al, injected electrons and ions into a linear quadrupole ion trap with a superimposed magnetic field, (T. Baba, Y. Hashimoto, H. Hasegawa, A. Hirabayashi and I. Waki, Anal Chem 76 4263-6 (2004) and see also published U.S. Patent Application 2005/0178955]. They used a TOF mass spectrometer to observe the daughter ions produced by ECD, including the characteristic c and z ions, and their ion production efficiency was comparable to Zubarev's (˜4% fragmentation efficiency for Substance P, 1347 Da). However, this group has recently employed a different configuration of the ion trap/TOF instrument with improved results (H. Satake, H. Hasegawa, A. Hirabayashi, Y. Hashimoto, T. Baba, and K. Matsuda, Anal. Chem. 79 8755-8761 (2007)). This device is claimed to have much higher efficiency, and also to be compatible with the HPLC time scale.

Nevertheless, this design may not represent the optimum configuration for an ECD quadrupole/TOF instrument. It appears to have a number of disadvantages including:

A complicated instrument geometry that requires the ion beam to be deflected 90 degrees by a quadrupole deflector in order to enter and leave the ECD cell. This probably introduces problems in alignment.

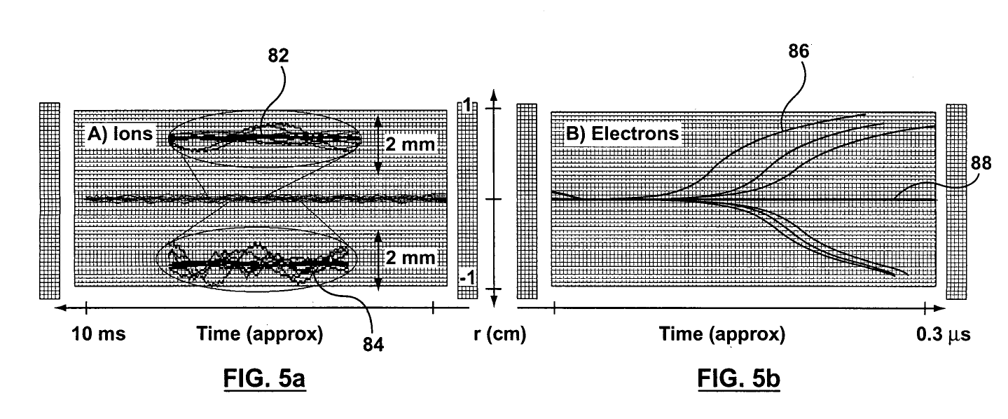

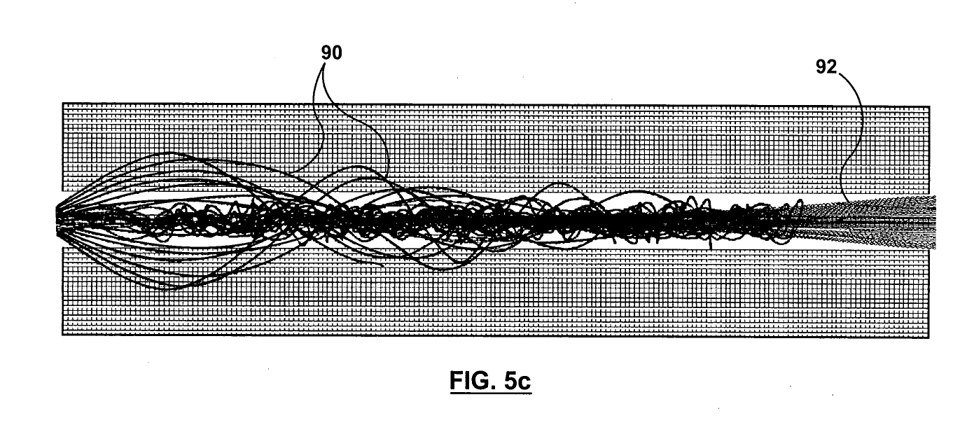

There may also still be the problem of electron heating produced by the quadrupolar electric field, which tends to move the electrons away from the axis, and shifts the electron energy to higher values, where the cross section for interaction is much smaller. The magnetic field exerts a constraining effect on the electrons, but this may not always be sufficient to keep them well focused on the axis (see calculations below in FIG. 5b).

### INTRODUCTION

The following introduction is intended to introduce the reader to this specification but not to define any invention. One or more inventions may reside in a combination or sub-combination of the apparatus elements or method steps described below or in other parts of this document. The inventor does not waive or disclaim his rights to any invention or inventions disclosed in this specification merely by not describing such other invention or inventions in the claims.

The present invention can use a geometry similar to a QqTOF spectrometer, for example a Sciex QqTOF spectrometer, but with an additional CID/ECD cell on the opposite side of the TOF section from the other quadrupoles. In the present invention, mass-selected and cooled ions are injected into this cell through the storage region of the accelerating column. An innovative circuit to drive the collision cell quadrupole with minimal electron excitation is also provided, in case the magnetic field is inadequate to provide sufficient electron confinement.

In accordance with a first aspect of the present invention, there is provided a mass spectrometer comprising:

a source of ions having desired characteristics;

a time-of-flight mass spectrometer section including a modulator having a storage region, and first and second apertures on opposite sides of the storage region of the modulator, the first aperture providing a connection to the source of ions; and

a cell, for at least one of collisional-induced dissociation and electron capture dissociation, connected to the storage region of the modulator of the time-of-flight mass spectrometer section by the second aperture, whereby, in use, ions from the source of ions can pass through the first aperture, the modulator and the second aperture into the cell, for at least one of collisional-induced dissociation and capture of electrons, in order to generate daughter ions, and the daughter ions are passed back into the time-of-flight mass spectrometer section for analysis.

The source of ions can comprise an electrospray ion source, by itself, or with the addition of a mass selection device comprising at least one mass selection quadrupole rod set. Alternatively, the ion source can comprise an electrospray or other source and a quadrupole or other multipole rod set configured to focus the ions (it is here noted that while the invention is generally described as using quadrupole rod sets, for some purposes other multipole rod sets could be used.) while they are being cooled by collisions with a gas.

In accordance with another aspect of the present invention, there is provided a mass spectrometer comprising a source of ions of a desired mass, a mass analysis device having first and second connection apertures, with the first connection aperture providing a connection to the source of ions, and the second aperture providing a connection to a cell, for at least one of collision-induced dissociation and electron capture dissociation, The cell is connected to the mass analyzer by the second aperture, whereby ions from the source of ions can be passed through the mass analyzer into the cell to generate secondary ions, and the secondary ions are passed back into the mass analyzer for analysis.

The present invention also provides a method of mass analysis of ions, the method comprising:
(i) providing a supply of ions having desired characteristics;
(ii) passing the ions through the modulator storage region of a time-of-flight mass analysis section;
(iii) passing the ions into a cell at energies suitable for at least one of collision-induced dissociation and electron capture dissociation to produce secondary ions;
(iv) for either collision-induced dissociation or electron capture dissociation supplying a collision gas to the cell, and for electron capture dissociation supplying electrons to the cell; and
(v) passing the secondary ions into the time-of-flight mass spectrometer section for analysis.

Another aspect of the method of the present invention comprises:
providing a supply of ions having desired characteristics;
(ii) passing the ions through a mass analysis section;
(iii) passing the ions into a cell and supplying at least one of electrons to the cell for electron capture dissociation whereby the ions capture electrons to generate secondary ions, and a collision gas whereby the ions collide with the gas to generate secondary ions; and
(iv) passing the secondary ions into the mass analysis section for analysis.

The present invention also provides an electron capture cell comprising an electron source, a multipole rod set, and inlet aperture at one end for ions, a cathode for generating electrons at another opposite end thereof, a solenoid around the multipole rod set and a device for imparting an axial electric field along the rod set whereby, in use, an axial electric field can be established tending to drive electrons away from the inlet aperture and to drive positive ions generated in the electron capture cell towards the inlet aperture.

An additional aspect of the method of the present invention comprises effecting electron capture dissociation, the method comprising:

a) providing an electron capture cell with a multipole rod set to guide ions;

b) supplying positive ions at one end of the capture cell, and supplying electrons from another opposite end of the cell in the opposite direction to the supply of the ions;

c) providing an electric field along the electron capture cell tending to drive the positive ions towards one end thereof and to drive the electrons towards the other end thereof.

### DETAILED DESCRIPTION OF THE DRAWINGS

For better understanding of the present invention and show more clearly how it may be carried into effect, reference will now be made, by way of example, to the accompanying drawings in which:

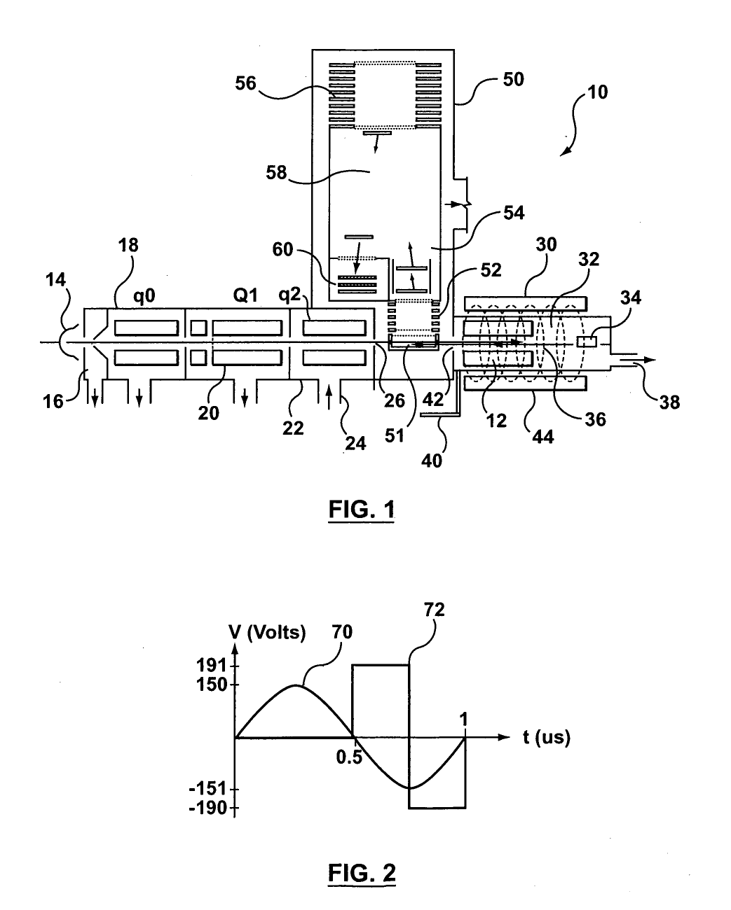

FIG. 1 is a schematic diagram of a mass spectrometer in accordance with the present invention;

FIG. 2 is a graph showing a waveform for excitation of a quadrupole for performance of ECD in the mass spectrometer of FIG. 1;

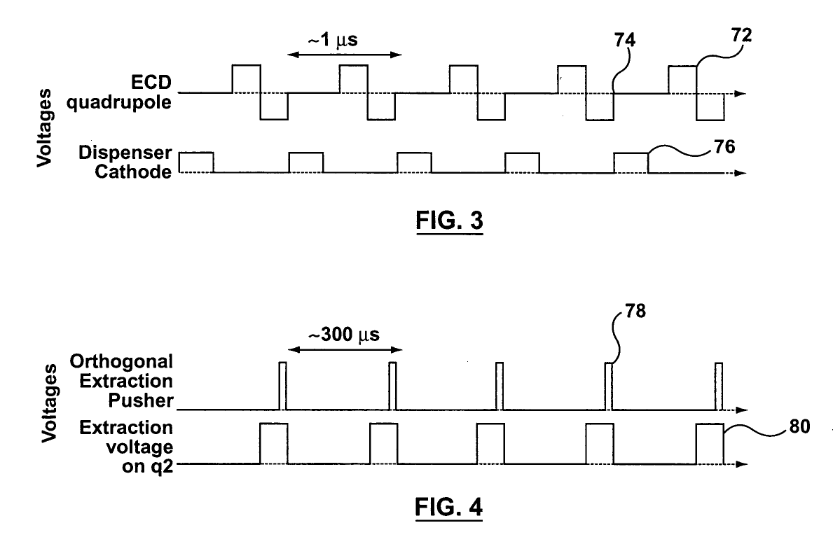

FIG. 3 shows a possible synchronization of pulses applied to a dispenser or field effect cathode with a waveform applied to the quadrupole in the electron collision cell;

FIG. 4 is a graph showing synchronization of the extraction voltage on a quadrupole within an upstream mass selection section with the extraction voltage in a time-of-flight section of the mass spectrometer of FIG. 1;

FIG. 5a is a simulation of ion trajectories in a quadrupole rod set under different driving voltages, and

FIG. 5b is a simulation of electron trajectories in the quadrupole rod set under different driving voltages;

FIG. 5c is a simulation showing ions and electrons traveling in opposite directions;

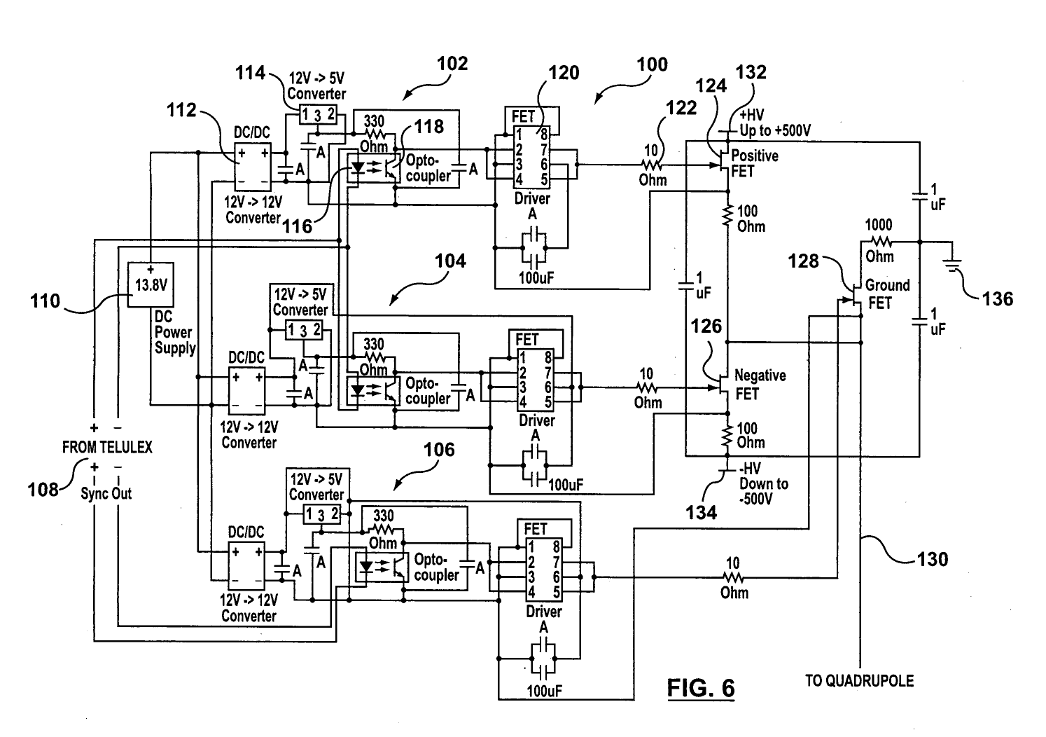

FIG. 6 is a schematic diagram of a driver circuit for generating the square waveform of FIG. 2; and

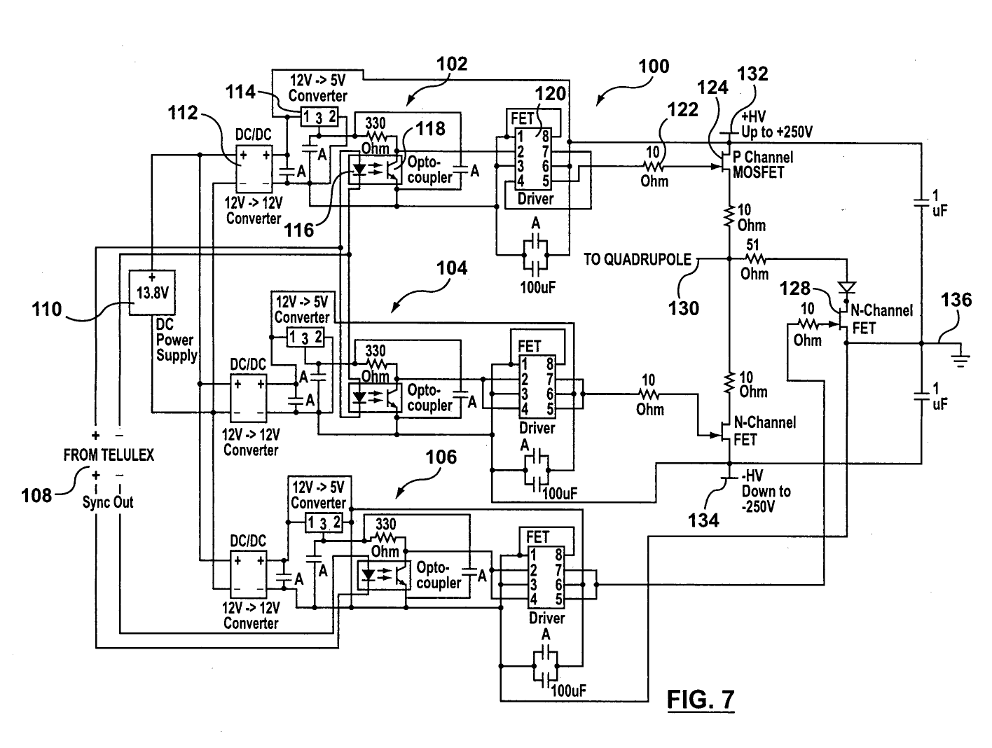

FIG. 7 is a schematic diagram of another driver circuit for generating the square waveform of FIG. 2.

### DETAILED DESCRIPTION

Various apparatuses or methods will be described below to provide an example of an embodiment of each claimed invention. No embodiment described below limits any claimed invention and any claimed invention may cover apparatuses or methods that are not described below.

The claimed inventions are not limited to apparatuses or methods having all of the features of any one apparatus or method described below or to features common to multiple or all of the apparatuses described below. It is possible that an apparatus or method described below is not an embodiment of any claimed invention. The applicants, inventors and owners reserve all rights in any invention disclosed in an apparatus or method described below that is not claimed in this document and do not abandon, disclaim or dedicate to the public any such invention by its disclosure in this document.

Additionally, reference is made, in the detailed description and elsewhere, to various prior publications, in the patent and non-patent literature, and the contents of all of these are hereby incorporated by reference.

FIG. 1 shows an embodiment of the invention, for producing either CID or ECD in a relatively simple configuration derived from a QqTOF spectrometer, for example a Sciex QqTOF spectrometer. One aim is not to do “top-down” sequencing, for which the “unlimited” m/z range of the TOF spectrometer is suitable, but for which the FTICR instrument has unique advantages in resolution. Instead, the inventors plan to improve “bottom up” sequencing by exploiting the ability of ECD to break up large ions. Thus the sample will be digested, as in conventional “bottom up” sequencing, but with more selective proteases, such as LysC, (instead of trypsin), and/or with shorter digestions (in order to create additional missed cleavages). This will produce considerably larger proteolytic peptides, which can still be broken up by ECD because of the large amount of recombination energy available. Further breakups of the daughter ions by successive electron captures may follow, as shown by Satake et al (citation above), thus producing lower charge ions, and simplifying the spectrum, The combination of a large peptide (which makes it easier to fit the daughter ion sequences together), the relatively simple spectrum produced from a low-charge ion, and the high absolute mass accuracy obtainable in a TOF instrument for daughter ions with m/z values up to a few thousand, should be a potent recipe for bottom-up sequencing. This procedure also avoids the need to carry out a separate set of reactions (proton transfer) to simplify the spectrum, as is often necessary in ETD. The geometry of the mass spectrometer, indicated generally at 10 in FIG. 1, is similar to that in the QqTOF (electrospray version) (A. Loboda, A. Krutchinsky, M. Bromirski, W. Ens, and K. G. Standing, Rapid Commun. Mass Spectrom. 14 1047-1057 (2000)). However, an additional (CID/ECD) collision cell 12, or q₃, has been inserted on the other side of a TOF section 50 of the TOF instrument.

An ion source 14 is an electrospray source, which provides parent ions with charge 2 or more. An intermediate pressure chamber 16 of the mass spectrometer receives the ions, and from this chamber 16 the ions pass through into a chamber 18 with a first quadrupole rod set, commonly designated q₀. From the chamber 18, the ions pass through into a chamber 20 having a second quadrupole rod set, again by common convention often designated as Q₁. As indicated, this rod set can be provided with a short set of rods, often designated as “stubbies” and providing a Brubaker lens. From the chamber 20, the ions pass through into a chamber 22 provided with a third quadrupole rod set, again by common convention often designated q₂.

As shown for the chambers 16, 18, and 22, connections can be provided to gas sources and to vacuum pumps to maintain desired pressures within these chambers. Chambers 16, 18, and 22 are supplied with a chemically non-reactive gas (nitrogen, helium, argon, xenon, or similar) maintained at intermediate pressures (˜10⁻² Torr−1 Torr) to provide collisional cooling, while chamber 20 should have a good vacuum (˜10⁻⁵ Torr).

Additionally, in known manner connections to the rod sets would be provided to AC and DC voltage supplies. For simplicity, vacuum and voltage supplies and other conventional peripherals are not shown.

The additional CID/ECD cell 12 provides a collisional dissociation/electron capture chamber 30 including another quadrupole rod set q3. It is attached to an electron source chamber 32 including a cathode 34 providing a source of electrons. An aperture 36 is provided between the chambers 32 and 12. The electron source chamber 32 has a connection 38, for connection to a vacuum source to maintain a desired low pressure (˜10⁻⁵ Torr). Due to the possible high gas loads imposed by the collision gas in the enclosure around the quadrupole for ECD, a hafnium carbide cathode may be used. It is more durable than other possible cathodes (tungsten filament, lanthanum hexaboride, and others) in the presence of higher pressures and can tolerate pressures of up to 10⁻⁴ Torr. The electron collision chamber 32 is provided with a connection 40 for supply of chemically non-reactive gas (nitrogen, helium, argon, xenon, or similar) to create a pressure of between 1 and 100 milliTorr. A solenoid 44 capable of generating an axial magnetic field of greater than 100 Gauss for guiding electrons is provided around the chambers 30, 32. Ions to or from the ECD cell pass through a pair of apertures (typically 2 mm diameter from the output of the quadrupole; a horizontal rectangular aperture typically 1.5 mm by 6 mm) and various ion optical elements, connected to the TOF modulator region. These are designed to minimize vertical spread in the ion beam and thereby improve resolution.

The TOF section 50 includes a modulator 52 with a storage region 51, and an acceleration column or region 54 extending upwards in this view from the storage region 51, including an orthogonal pusher electrode in known manner. The acceleration region 54 of the modulator 52, in use, causes ions to travel towards an ion mirror 56 through a field free drift region 58, in which ion separation can occur. In known manner, the ion mirror 56 reverses the motion of the ions and directs them towards a four anode detector 60.

The other unmodified sections of the mass spectrometer are operated in the conventional manner. There may be the need for additional ion focusing elements at the exit of q2.

In use, ions generated from the electrospray source 14 pass through the intermediate chamber 16 and are cooled within the first quadrupole rod set q₀ in the chamber 18. The second quadrupole rod set Q₁ is operated to mass select ions of interest, and the mass selected ions pass into the chamber 22, where the third rod set q₂ is operated to focus the ions while cooling is accomplished through collisions with the bath gas.

In accordance with the present invention, the selected, cooled and focused ions from the chamber 22 then pass through a first connection aperture 26 into the storage region 51 of the time-of-flight modulator 52 At this time, no orthogonal extraction pulses are applied to the pusher electrode. Rather, the ions are permitted to travel through the storage region 52 and through a second set of apertures and ion optics 42 into the CID/ECD chamber 30.

It can be noted that the quadrupole q₂ in chamber 22, usually operated as a collision cell in the conventional qQTOF configuration, now simply serves to provide additional cooling and pulsing for the mass selected ions; as is explained below, q2 and the chamber 22 can be used to store ions and permit them to pass through the aperture 26 in pulses.

Electrons are emitted from the dispenser cathode 34 in a fairly high vacuum (less than ˜10⁻⁴ Torr) and then pass into the electron capture chamber 30, of the ECD cell 12, through an axial aperture at the end of the quadrupole. These low energy electrons are confined by a longitudinal magnetic field produced by the solenoid 44 surrounding the quadrupole rod set q3 and the chambers 30, 32, so that they spiral along the axial magnetic lines of force. As detailed below, the electron beam may be pulsed so as to coincide with the zero-field part of the TOF waveform, or operated continuously.

This physical arrangement has several advantages, including:

The simple geometry, providing direct axial intersection of the ion and electron beams, and making it much easier to provide the required spatial overlap;

A simple magnetic field configuration (solenoid), with easy adjustment of magnetic field strength. Once optimum magnetic field conditions are determined, the solenoid could possibly be replaced by a permanent magnet configuration;

Positioning of the electron source within the magnetic field of the solenoid, thus minimizing the effects of space-charge blowup and allowing the use of high electron currents;

Separation of the functions of parent ion selection (in Q₁), and collisional cooling of the selected ions (in q₂), thus providing a high quality beam for transport between q₂ and the ECD cell;

Minimal exposure of the electron source to the most serious contaminants, such as oxygen; and

The ability to use alternate modes of operation (see below).

The quadrupole excitation can be modified by the use of a square waveform, instead of the conventional sinusoidal waveform. A square wave excitation yields performance comparable with that delivered by the usual sinusoidal excitation, as well as additional flexibility. However, the present inventors have realized that it also has an additional advantage in this particular case. This is the ability to tailor the waveform so as to provide zero quadrupole field for a reasonable fraction of the RF cycle, during which time the electrons are not accelerated by the RF field (H Wang, Y Wang D. Kennedy, Y Zhu and K Nugent, 53^{rd} American Soc. for Mass Spectrometry, San Antonio Tex. June 2005, Poster TP 23, Berkout U.S. Pat. No. 6,858,840). Other methods for generating a zero-field interval in the quadrupole excitation waveform are also envisioned, including incorporating a zero-field interval into every period of a triangular or sinusoidal waveform, intermittently shutting off the excitation field, or forming the waveform from mixing of two sine waves with slightly different frequencies. However, these other solutions introduce greater complication and less flexibility than the method of rectangular waveform excitation.

For example, a quadrupole driver constructed for this purpose (and discussed in greater detail below) can be programmed to produce the idealized voltage shown at 72 in FIG. 2. The superimposed and conventional sinusoidal waveform normally used in such quadrupoles is indicated at 70. The amplitudes of the signals 70, 72 in FIG. 2 are chosen so that their integrated positive voltages are equal.

In addition, the quadrupole rod set in the electron collision chamber 30 is provided with extra electrodes between the quadrupole rods, in order to provide an axial field, or the quadrupole rods ion can be configured to generate the field. These additional electrodes or modifications can be in accordance with the U.S. Pat. No. 6,111,250, hereby incorporated by reference, although the configuration may be that described in A. Loboda, A. Krutchinsky, O. Loboda, J. McNabb, V. Spicer, W. Ens, and K. G. Standing, “Novel Linac II Electrode Geometry for Creating an Axial Field in a Multipole Ion Guide”, Eur. J. Mass Spectrom. 6 531-536 (2000).

In use, ions from the ion source 14 pass into the quadrupole q₀ in the first chamber 18, and then pass through the quadrupole Q₁ in the second chamber 24 for mass selection. The mass selected ions are then cooled and focused on the axis by the quadrupole q₂ in chamber 22.

As shown in FIG. 4, a small pulsed DC offset 80 is provided at the outlet of the chamber 22, as an ion shutter. As detailed below, this offset voltage 80 is synchronized with an orthogonal extraction pusher voltage 78. This synchronization is such that the voltage 80 is high, preventing passage of ions into the time-of-flight section 50, when ions leaving q2 would be accelerated into the field free drift region 58 by the extraction pulse intended for secondary ions emerging from the ECD cell. As indicated, the period for each cycle is approximately 300 microseconds. After each pulse applied as the extraction voltage, the voltage on q2 goes low, to permit ions to pass through the storage region of the modulator when no extraction field is present.

The effect of this is that ions pass out of the rod set q2 into the storage region of the modulator 52, and then pass straight through into the electron capture chamber 30 with no loss of ions into the TOF spectrometer.

In the electron collision chamber 30, a pulse of electrons is injected at the beginning of the zero field interval. It then slows down gradually and finally reverses direction. This is caused by the presence of a small DC axial voltage gradient that may be generated by specially shaped LINAC (linear accelerator) electrodes such as those described in (A. Loboda, A. Krutchinsky, O. Loboda, J. McNabb, V. Spicer, W. Ens, and K. G. Standing, “Novel Linac II Electrode Geometry for Creating an Axial Field in a Multipole Ion Guide”, Eur. J. Mass Spectrom. 6 531-536 (2000). The polarity is chosen such that the ion aperture end of the quadrupole for ECD is at a lower potential than the electron aperture end. This arrangement causes both ions and electrons entering from their respective ends to slow down and reverse direction. The electrons always have very low energy, and in fact reach zero axial velocity when they turn around, thus maximizing the cross section for capture. This process is repeated, with a pulse of electrons injected once in every q₃ RF cycle, as shown in FIG. 3. Electrons, for example, may have initial energies of the order of 10 eV or a few 10's of electron volts. It is not practical to predict interaction cross sections for the large biomolecules envisioned, but calculations on simpler systems are given by [D. R. Bates, Adv. Atomic Molec. Physics 34, 427-486 (1994) and C. Rebrion-Rowe, Int Rev. Phys. Chem 16, 201-213 (1997)]. They indicate that the cross section for electron capture increases significantly as the electron energy decreases.

FIG. 3 shows at 74 the waveform applied to the quadrupole in the electron capture chamber 30, as shown in greater detail in FIG. 2. There are two envisioned methods of operation for the electron source: pulsed emission and continuous emission. With continuous emission, the electron source produces a continuous stream of free electrons that are able to penetrate into the ECD quadrupole and interact with ions during the field-free fraction of the quadrupole waveform. During the positive and negative parts of the quadrupole waveform, the electrons are deflected from the quadrupole axis by the field from the quadrupole rods, so they do not interact with the ions in the cell. This method of operation is believed to be more appropriate for thermionic cathodes. For a pulsed source, this may be effected by providing a grid immediately adjacent to the actual source, and applying a control voltage to it to control emission of electrons. During the positive and negative parts of the quadrupole waveform, no voltage is applied to the control grid and hence no electrons are emitted. This method of operation is more appropriate for electron sources that can produce increased current densities when operated in a pulsed fashion. This is illustrated in FIG. 3. At the start of each RF cycle, indicated at 74, the voltage is applied to the grid, and the electron current is indicated by the waveform 76.

The electrons trapped radially by the magnetic field, and longitudinally by the electric field of the LINAC, make a double pass, forward and back, through the ion distribution in the quadrupole in the electron capture chamber 30. Calculations below show that the electron density can be high before space charge becomes a limiting factor.

The injected parent ions from the chamber 22 will slow down to thermal energies in the ECD cell or chamber 30 mainly by collisions with the gas, as in the present QqTOF spectrometer. The energies of the ion and electron beams entering the ECD cell will be set to give optimum overlap between the distributions.

That is, the region in which the ions lose their kinetic energy to the electric field and bath gas collisions, and then reverse direction, will coincide with the region in which the electric field causes electrons to lose their longitudinal velocity and finally reverse direction. Having electrons and ions intersect with low kinetic energy, as is done here, maximizes the efficiency of the ECD process.

After ECD, the daughter or secondary ions, being positive ions, will drift back to the entrance or second aperture 42 of the electron collision chamber 30 in response to the small axial electric field mentioned above, and will be injected into the TOF storage region for acceleration into the flight path of the TOF spectrometer.

Since the ion beams are so diffuse, there is little or no problem with individual ions traveling in opposite directions intersecting along the path from the TOF accelerating region to the quadrupole for ECD. However, gating of ions passing though the aperture of the ECD quadrupole toward the TOF region is possible and could be accomplished by applying a periodic additional positive voltage to the aperture through which ions depart the CID/ECD quadrupole for ECD on the way to the TOF region. When this additional positive voltage is applied, ions would be repelled from the aperture and so remain in the quadrupole. Such pulses would be timed so that the voltage would not be applied when the accelerating voltage is on. Thus ions would only be allowed into the TOF region during acceleration pulses causing them to be propelled into the field-free drift region and impact the detector.

Simulations preformed using SIMION 7.0 (simulation software for electron and ion behaviour) illustrate the marked improvement in electron stability resulting from the rectangular waveform. Ion and electron trajectories in the quadrupole of the electron collision chamber 30 under different waveforms are shown in FIG. 5. A uniform magnetic field of 500 Gauss is supplied by the solenoid, and a uniform voltage gradient of 0.2 V/cm is produced by the additional electrodes. The time axes are shown in different directions, because the ions and the electrons flow in opposite directions.

As shown in FIG. 5a, parts of the ion trajectory are shown expanded at 82 and 84. The waveform 82 shows the motion of ions with a conventional sinusoidal excitation of the quadrupole, and the waveform 84 shows the ion motion with the modified square waveform 72 of FIGS. 2 and 3. As can be seen, ion stability is not significantly affected by the different waveforms.

On the other hand, referring to FIG. 5b, curves 86 show the electron motion with a conventional sinusodal waveform and line 88 shows motion with the modified square waveform 72. It is clear that electron stability has vastly improved under zero-field conditions.

Mean free path calculations show that the average distance traveled by the electrons between collisions in 0.1 Torr He is about 4 cm, so for an 8 cm quadrupole, about one quarter of the electrons will remain undeflected. As indicated in FIG. 5b, the electron transit time through an 8 cm long quadrupole is about 0.3 μs—sufficiently short so that the electrons can traverse the quadrupole and interact with the ions within the 0.5 μs zero-voltage window (at 1 Mhz), i.e., half the period of the waveform 72 when no voltage is applied.

Since the ions are traveling much slower, (˜0.1 cm/μs for 10 eV for a typical Substance P, vs ˜60 cm/μs for 1 eV electrons), the ions see the RF field averaged over many cycles, and follow stable trajectories just as with sinusoidal excitation. In addition, the radial focusing force will be enhanced by the potential depression along the axis caused by the electron space charge, (not calculated here). The effects of ion and electron collisions with the buffer gas were modelled in a SIMION 8.0 simulation that was supplemented by a separate program the inventors have devised in Perl, which is based on our earlier simulation (A. Krutchinsky, I Chernushevich, V. Spicer, W. Ens, K. G. Standing, JASMS 9(6) 569-579 (1998)). In both simulations, ions that enter the quadrupole with large angular or velocity spreads are seen to be quickly focused onto the quadrupole axis as they lose energy to the bath gas. After traveling a few cm along the axis of the damping quadrupole, the majority of the ions have been focused into a region within a few mm of the axis, where the electron density is highest, so there should be good overlap between the ion and electron beams. The results of the SIMION buffer gas simulation are presented in FIG. 5c, where ions entering from the left hand side are indicated at 90 and electrons entering from the right hand side are indicated at 92.

The invention, as described, has concentrated on the problem of coupling ECD to a TOF spectrometer. However, it is believed that the proposed configuration can be used for other measurements:

CID can be carried out in q₃ in the same way as is done in q₂ in the usual mode of qQTOF operation, i.e. with gas, but without an electron beam. It has been estimated that ˜60% of sequence information is obtained from ECD, and 40% from CID, when both modes of operation are available [Zubarev reference, mentioned above];

CID can also be carried out in q₂ exactly as in the usual mode of qQTOF operation, but in this case the ions must be deflected (by the deflection plates in the TOF section) in order to hit the detector, with a consequent loss of resolution. This is because the ions will have a velocity transverse to the acceleration direction in the TOF section. As viewed in FIG. 1, this is in the horizontal direction; ions coming out of the cell will have a horizontal velocity that will give a desired trajectory in the TOF section, while ions coming out of q₂ will have the opposite velocity. However, this mode may be useful for comparison with the normal mode of operation Substitution of a negative ion source for the electron source should enable ETD in q₃; one could therefore compare ECD and ETD in the same geometry.

Although a spectrometer as described has not yet been completed, the inventors the inventors have assembled an ECD cell and are in the process of attaching it to a mass spectrometer as described herein.

It is believed that care needs to be taken in the construction of the rectangular voltage generator necessary to drive the quadrupole q₃. Conventional sinusoidal generators use resonant circuits, but due to the rapid switching times necessary (less than 50 ns), the present design is based on power metal oxide field effect transistors (MOSFET's) as shown in FIG. 6. A simpler version, incorporating only one low-voltage transistor, may be used to pulse the electron source 34. The overall circuit is indicated at 100 and includes three FET driver circuits indicated generally at 102, 104 and 106, which have a generally similar configuration.

The desired rectangular wave is supplied from a programmable arbitrary waveform generator (Telulex Model SG-100, current equivalent now sold by Berkeley Nucleonics) and is transmitted to three transistor driving circuits, and its input is indicated at 108. The first FET driving circuit 102 is triggered by the positive part of the signal, the second FET driving circuit 104 is triggered by the negative part of the signal, and the third FET driving circuit 106 is triggered by a supplemental output that is turned on whenever the signal voltage is at 0V. The optocouplers for the positive (102) and negative (104) halves of the circuit trigger on the positive and negative portions of the square wave from the Telulex SG-100. The clamping portion of the circuit (106) is triggered by a secondary output from the Telulex SG-100, programmed to occur immediately after the signal which triggers portions (102) and (104).

In order to make the rise and fall times as short as possible, we have chosen components that minimize the effective RC time-constant of the circuit. This necessitates using low-value resistors, which in turn increases the power drawn by the circuit. When working in operation range, both halves of the device will generate a total of 100 W of heat, which will be dissipated by forced air cooling.

A common DC bench power supply 100, a 13.8 volt supply is connected to the three FET driving circuits, 102, 104 and 106. The three circuits 102, 104 and 106 are generally similar, and for simplicity are described in relation to the circuit 102; it being understood that the other circuits correspond.

The FET driving circuit 102 has a DC to DC converter 112 that converts the DC voltage to a floating 12 volts, so that the ground of each circuit portion is no longer tied to the Earth ground of the power supply. This is connected to a DC regulator 114 (part number LM7805) that converts the voltage to 5 volts to power the optocoupler.

The input from the Telulex at 108 is connected across an LED to provide electrical isolation. The output from the LED 116 is received by its corresponding transistor 118, so as together to form an optocoupler. The output from the transistor 118 is connected to a driver circuit 120. This package essentially provides dual inverting amplifiers connected between the pin pairs 2, 7 and 4, 5.

The output from the driver circuit 120 is connected through a resistor 122 to the gate of an FET 124.

Corresponding final drive FET's 126 and 128 are provided for the other drive circuits 104, 106. As shown, these FET's 124, 126, 128 are connected to a connection 130 that provides the input to the quadrupole. They are arranged in an H-bridge arrangement, as detailed below. Thus, the FET 124 has a connection to a 500 volt positive source 132, while the FET 126 is shown connected to a negative 500 volt source 134. The FET 128 provides a connection through to ground indicated at 136.

FIG. 6 shows a circuit for generating a positive-negative waveform, while FIG. 7 shows a circuit for generating negative-positive waveform. For simplicity as many components are common between the two figures, the same reference numerals are used for the two figures and the description above applies to both figures.

In FIG. 6, the polarity-form of the output waveform a P-channel FET128 pulls the quadrupole signal from −HV to “up” ground with a diode and 51-ohm resistor only permitting conduction from −HV up to zero volts. Conversely in the negative-positive waveform circuit, shown in FIG. 7, an N-channel FET128 pulls the quadrupole signal from +HV “down” to ground with the same diode and 51-ohm resistor, but the diode configured to only permit conduction from +HV down to zero volts.”

In a quadrupole, diagonally opposite rods are connected together. Here each of the circuits of FIGS. 6 And 7 is connected to one pair of rods to give the desired field.

It can be noted that the capacitors in the circuit denoted by A will; have a capacitance of 0.1 μF and are placed as close as possible to the supply pins on the integrated circuits to minimize unwanted oscillations. The DC to DC converters 112 are preferably ASTEC AEE 00B12-49 converters, the optocouplers are preferable HCPL2611 and FET drivers 120 are preferably TI (Texas Instruments) UCC27323 with the final drive FET's 124, 126 and 128 preferably being IRF 830, and the P-channel MOSFETS preferably being MTP 2P50E.

1. A mass spectrometer comprising:
a source of ions having desired characteristics;
a time-of-flight mass spectrometer section including a modulator having a storage region and first and second apertures on opposite sides of the storage region of the modulator, the first aperture providing a connection to the source of ions; and
a cell, for at least one of collision-induced dissociation and electron capture dissociation, connected to the storage region of the modulator of the time-of-flight mass spectrometer section by the second aperture, whereby, in use, ions from the source of ions can pass through the first aperture, the modulator and the second aperture into the cell, for at least one of collision-induced dissociation and capture of electrons, to generate daughter ions, and the daughter ions are passed back into the time-of-flight mass spectrometer section for analysis.

2. A mass spectrometer as claimed in claim 1, wherein the cell comprises a multipole rod set and a solenoid around the multipole rod set, and wherein the source of electrons comprises a cathode.

3. A mass spectrometer as claimed in claim 2, wherein the cell, includes an electron capture chamber housing the multipole rod set and an electron source chamber housing the cathode, and wherein the solenoid is located around the electron capture chamber and the electron source chamber.

4. A mass spectrometer as claimed in claim 3, wherein the electron capture chamber includes a connection for a collision gas.

5. A mass spectrometer as claimed in claim 4, wherein the multipole rod set comprises a quadrupole rod set.

6. A mass spectrometer as claimed in claim 5, wherein the quadrupole rod set includes an axial field generation device.

7. A mass spectrometer as claimed in claim 6, wherein the axial field generation device comprises one of:
an additional set of electrodes mounted between the rods of the quadrupole rod set;
an arrangement of the rods of the quadrupole rod set to provide the axial field; and
electrodes at both ends of the rod set with differing voltages applied to them.

8. A mass spectrometer as claimed in claim 6, wherein the source of ions comprises an ion source and a mass selection device for selecting ions having a desired mass or a range of masses.

9. A mass spectrometer as claimed in claim 8, wherein the ion source comprises an electrospray ion source, and wherein the mass selection device comprises at least one mass selection quadrupole rod set.

10. A mass spectrometer as claimed in claim 9, wherein at least one mass selection quadrupole rod set comprises a first quadrupole rod set for cooling and focusing ions, a second quadrupole rod set for mass selection of ions of a desired mass, and a third quadrupole rod set for cooling and focusing ions prior to passage of ions through the first aperture into the acceleration region of the time-of-flight mass spectrometer section.

11. A mass spectrometer as claimed in claim 2, wherein the time-of-flight mass spectrometer section comprises the modulator including an acceleration region, a field free drift region, an ion mirror and an anode detector.

12. A mass spectrometer as claimed in claim 2, including a square wave generator connected to the cell quadrupole rod set.

13. A mass spectrometer as claimed in claim 12, wherein the square wave generator generates a square waveform comprising, in each cycle, a square wave and a period of zero voltage.

14. A mass spectrometer as claimed in claim 13, wherein the cell includes a cathode drive circuit connected to the cathode, with a connection between the cathode drive circuit and the square wave generator, to synchronize the application of a voltage to the cathode, whereby voltage is applied to the cathode at the start of the period of zero voltage in each cycle.

15. A mass spectrometer as claimed in claim 10, wherein the modulator includes an extraction electrode, and further including an orthogonal extraction voltage circuit connected to the extraction electrode of the modulator and an ion shutter for the third quadrupole, the orthogonal extraction circuit and the shutter being synchronized, whereby passage of ions from the third quadrupole through the first aperture is blocked during application of the orthogonal extraction voltage to the extraction electrode.

16. A mass spectrometer as claimed in claim 1, including a source of negative ions for injection into the cell.

17. A mass spectrometer as claimed in claim 1, wherein the cell includes an input for supply of a collisional dissociation gas.

18. A mass spectrometer as claimed in claim 10, wherein the third quadrupole rod set is adapted to provide collision induced dissociation (CID), to generate secondary ions for passage through to the electron capture cell.

19. A mass spectrometer comprising a source of ions of a desired mass, a mass analysis device having first and second connection apertures, with the first connection aperture providing a connection to the source of ions, and a cell, for at least one of collision-induced dissociation and electron capture dissociation, connected to the mass analyzer by the second aperture, whereby ions from the source of ions can be passed through the mass analyzer into the cell to generate secondary ions, and the secondary ions are passed back into the mass analyzer for analysis.

20. A mass spectrometer as claimed in claim 19, wherein the cell includes an electron source, a multipole rod set, a solenoid around the multipole rod set and a device for imparting an axial electric field along the rod set whereby, in use, an axial electric field can be established tending to drive electrons away from the second aperture and to drive positive ions generated in the cell towards the second aperture.

21. A method of mass analysis of ions, the method comprising:
(i) providing a supply of ions having desired characteristics;
(ii) passing the ions through the modulator region of a time-of-flight mass analysis section;
(iii) passing the ions into a cell at energies suitable for at least one of collision-induced dissociation and electron capture dissociation to produce secondary ions;
(iv) for either collision-induced dissociation or electron capture dissociation supplying a collision gas to the cell, and for electron capture dissociation supplying electrons to the cell; and
(v) passing the secondary ions into the time-of-flight mass spectrometer section for analysis.

22. A method as claimed in claim 21, including providing the cell with one of a solenoid and a permanent magnet, to provide a magnetic field to guide electrons, and providing an axial electric field along the cell, the field tending to drive electrons away from the second aperture and to drive secondary, generated ions towards the second aperture.

23. A method as claimed in claim 22, including supplying gas to the cell.

24. A method as claimed in claim 23, including providing a multipole rod set to guide and focus ions and electrons within the cell.

25. A method as claimed in claim 24, including:
(a) generating ions from an electrospray ion source;
(b) cooling and focusing the ions and mass selecting ions in a mass selector; and
(c) supplying the mass selected ions to the first aperture.

26. A method as claimed in claim 25, including mass selecting ions in step (b) in a quadrupole rod set.

27. A method as claimed in claim 24, including supplying a waveform to the multipole rod set of the cell, in which each cycle of the waveform comprises an alternating component and a period with zero voltage, wherein, at the start of each period of zero voltage, electrons are supplied to the cell.

28. A method as claimed in claim 27, including providing a periodic extraction voltage to the acceleration region of the time-of-flight mass spectrometer, and applying a voltage to prevent passage of ions through the first aperture during the application of the modulator extraction voltage.

29. A method of a mass analysis of ions, the method comprising:
providing a supply of ions having desired characteristics;
(ii) passing the ions through a mass analysis section;
(iii) passing the ions into a cell and supplying to the cell at least one of electrons for electron capture dissociation whereby the ions capture electrons to generate secondary ions, and a collision gas whereby the ions collide with the gas generates secondary ions; and
(iv) passing the secondary ions into the mass analysis section for analysis.

30. An electron capture cell comprising an electron source, a multipole rod set, and inlet aperture at one end for ions, a cathode for generating electrons at another opposite end thereof, a solenoid (or magnet) around the multipole rod set and a device for imparting an axial electric field along the rod set whereby, in use, an axial electric field can be established tending to drive electrons away from the inlet aperture and to drive positive ions generated in the electron capture cell towards the inlet aperture.

31. A method of effecting electron capture dissociation, the method comprising:
a) providing an electron capture cell with a multipole rod set to guide ions;
b) supplying ions at one end of the capture cell, and supplying electrons from another opposite end of the cell in the opposite direction to the supply of the ions;
c) providing an electric field along the electron capture cell tending to drive the ions towards one end thereof and to the drive the electrons towards the other end thereof.

32. A method as claimed in claim 31, including providing an axial magnetic field along the electron capture cell to guide the electrons.

33. A method as claimed in claim 32, including providing an alternating field to the multipole rod set including a period of zero voltage in each cycle and generating the electrons from the cathode during the periods of zero voltage.
